(19) United States
(12) Patent Application Publication
(10) Pub. No.: US 2009/0109187 A1
(43) Pub. Date: Apr. 30, 2009

(54) INFORMATION PROCESSING APPARATUS, LAUNCHER, ACTIVATION CONTROL METHOD AND COMPUTER PROGRAM PRODUCT

(75) Inventor: Tatsuyoshi NOMA, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 12/237,679

(22) Filed: Sep. 25, 2008

(30) Foreign Application Priority Data
Oct. 30, 2007 (JP) 2007-282079

(51) Int. Cl. G06F 3/041

(52) U.S. Cl. 345/173

(57) ABSTRACT

According to one embodiment, an information processing apparatus with a display device and a contact input device arranged on the display device and receiving data corresponding to a contact position of a finger includes a detecting unit, a GUI determination unit, and a display control unit. The detecting unit detects a movement pattern of the finger touching the contact input device. The GUI determination unit determines a launcher GUI (Graphical User Interface) including one or more icons in accordance with the movement pattern detected by the detecting unit. The display control unit displays the launcher GUI determined by the GUI determination unit on the display device in accordance with the contact position of the finger on the contact input device.

### CROSS-REFERENCE TO RELATED APPLICATIONS

This application is based upon and claims the benefit of priority from Japanese Patent Application No. 2007-282079, filed Oct. 30, 2007, the entire contents of which are incorporated herein by reference.

### BACKGROUND

1. Field

One embodiment of the invention relates to a technology for activating a launcher.

2. Description of the Related Art

An information processing apparatus including a personal computer has been used for various applications such as receiving, viewing, video recording/reproducing of digital broadcast programs in addition to document creation, spreadsheet calculation, Web site browsing, and becomes widely popular for household use and business use. There are a desktop type in which a display device and a main body are separated, and a portable type in this type of information processing apparatuses. There are a notebook type in which a display device and a main body are integrated, and a type in a size portable with one hand in the portable information processing apparatuses.

Incidentally, a user interface function with which a user can easily select an arbitrary function is required in the information processing apparatus including the various functions as stated above. There is a launcher as one of the user interface functions as stated above. The launcher is a function of registering application programs and files used frequently, and activating them directly.

The information processing apparatus can activate an application program associated with an icon in response to selection of the icon displayed on a screen by this launcher. Such a conventional information processing apparatus operating by the launcher is disclosed in, for example, Japanese Patent Application Publication (KOKAI) No. 2003-233454.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view of an external appearance of a computer as an information processing apparatus according to an embodiment of the invention;

FIG. 2 is an exemplary block diagram of an internal configuration of the computer in FIG. 1 in the embodiment;

FIG. 3 is an exemplary schematic view of a positional relationship between a liquid crystal panel and a touch panel in the embodiment;

FIGS. 4A and 4B are exemplary views of a display pattern determination table, in which “left and right both sides” is not included or “left and right both sides” is included in the embodiment;

FIG. 5 is an exemplary flowchart of an operation procedure of a launcher activation control process in the computer in the embodiment;

FIG. 6 is an exemplary view of an external appearance of the computer before a finger is moved in a first finger gesture in the embodiment;

FIG. 7 is an exemplary view of an external appearance of the computer when the finger is moved in the first finger gesture in the embodiment;

FIG. 8 is an exemplary view of an external appearance of the computer after the first finger gesture in the embodiment;

FIG. 9 is an exemplary view of an external appearance of the computer after a launcher button is displayed in the embodiment;

FIG. 10 is an exemplary view of an external appearance of the computer after a launcher GUI is displayed in the embodiment;

FIG. 11 is an exemplary view of an external appearance of the computer after another launcher GUI is displayed in the embodiment;

FIGS. 12A and 12B are exemplary views of examples of the launcher GUI, one corresponding to FIG. 10 and the other corresponding to FIG. 11 in the embodiment;

FIG. 13 is an exemplary flowchart of an operation procedure of another launcher activation control process in the computer in the embodiment;

FIG. 14 is an exemplary view of an external appearance of the computer after the launcher button is displayed when the launcher activation control process is performed according to the flowchart in FIG. 13 in the embodiment; and

FIG. 15 is an exemplary view of an external appearance of the computer when the launcher GUI is displayed after the launcher button illustrated in FIG. 14 is displayed in the embodiment.

### DETAILED DESCRIPTION

Various embodiments according to the invention will be described hereinafter with reference to the accompanying drawings. In general, according to one embodiment of the invention, an information processing apparatus including a display device and a contact input device arranged on the display device and receiving data corresponding to a contact position of a finger includes the following units. Namely, the information processing apparatus includes: a detecting unit that detects a movement pattern of the finger touching the contact input device; a GUI determination unit that determines a launcher GUI (Graphical User Interface) including one or more icons in accordance with the movement pattern detected by the detecting unit; and a display control unit that displays the launcher GUI determined by the GUI determination unit on the display device in accordance with a contact position of the finger on the contact input device.

According to another embodiment, a launcher activation control method applied to an information processing apparatus including a display device and a contact input device arranged on the display device and receiving data corresponding to a contact position of a finger, includes: detecting a movement pattern of the finger touching the contact input device; determining a launcher GUI including one or more icons in accordance with the movement pattern detected at the detecting; and displaying the launcher GUI determined at the determining on the display device in accordance with a contact position of the finger on the contact input device.

According to still another embodiment, a computer program product implements the above method on a computer.

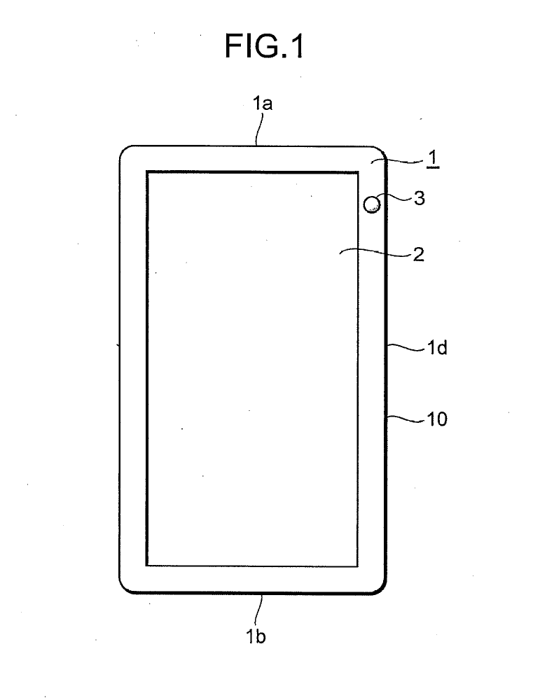

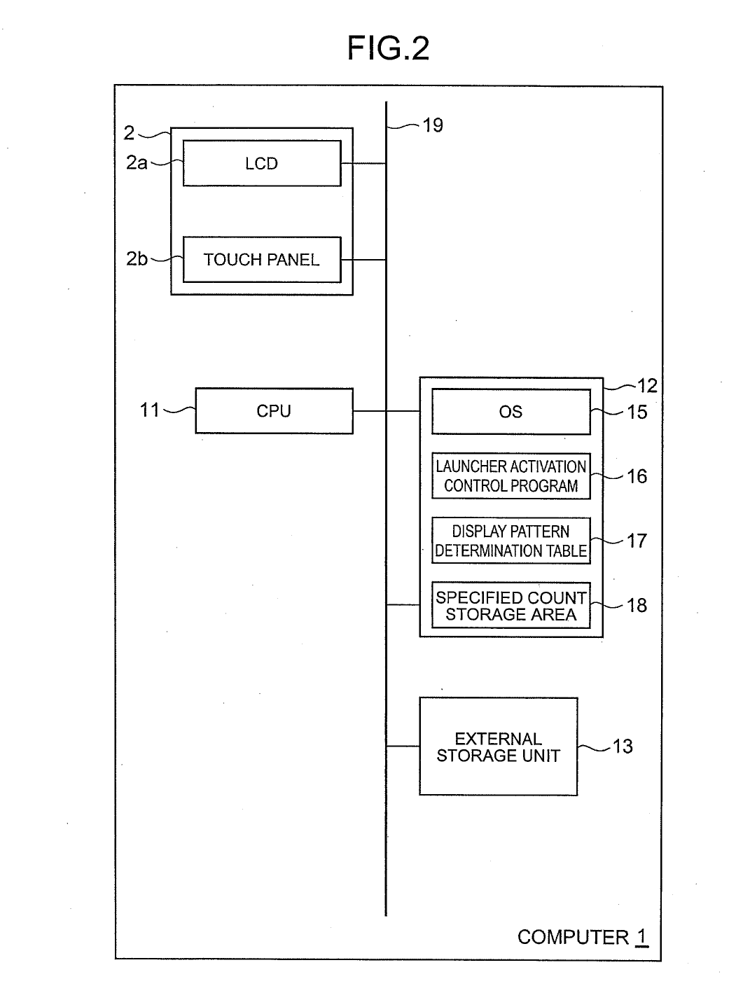

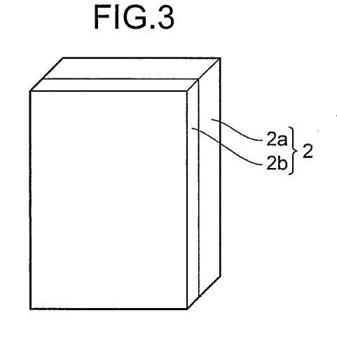

FIG. 1 is a plan view of an external appearance of a computer 1 as an information processing apparatus according to an embodiment of the present invention. FIG. 2 is a block diagram of an internal configuration of the computer 1. FIG. 3 is a schematic view of a positional relationship between a liquid crystal panel 2a and a touch panel 2b.

As illustrated in FIG. 1, the computer 1 is a tablet type computer in a size portable with one hand, including a rectangular main body 10 in substantially tabular form. The computer 1 is used for portrait display as illustrated in FIG. 1 in the present embodiment, and an upper side is an upper portion 1a, a lower side is a lower portion 1b, a left side is a left portion 1c, and a right side is a right portion 1d of the main body 10 in this case.

The computer 1 includes a display unit 2 in a size occupying almost a whole area including a center of one side, and a power switch 3 disposed at an outside of the display unit 2.

The display unit 2 is an image display device, having the liquid crystal panel (LCD) 2a as illustrated in FIG. 2, and constitutes one of output devices of the computer 1. The display unit 2 has the liquid crystal panel 2a and the touch panel 2b, and displays later-described launcher GUIs (Graphical User Interfaces) 120, 130 and so on, on the liquid crystal panel 2a when a predetermined operation by using a finger is performed.

The touch panel 2b is a contact input device, disposed on a front-surface side (visible side) of the liquid crystal panel 2a as illustrated in FIG. 3, senses a pressure and a static electricity and so on applied by using input units such as a finger or a stylus pen, and inputs data indicating the pressure and so on to a CPU 11. The computer 1 allows a user to perform operations such as data input and command input by, for example, touching the display unit 2 with his finger or a stylus pen (not illustrated) and writing characters directly on its screen instead of using operation input units such as a keyboard and a touch pad.

The power switch 3 is a main power switch of the computer 1, and when pressed down, the computer 1 is turned on.

On the computer 1, an OS (operating system) 15 such as Windows (registered trademark) is installed, and it is possible to execute a plurality of programs simultaneously under the control of the OS 15. Although not shown, program execution windows can be displayed on the display unit 2. It is possible for the user to adjust the position and size of the windows, and to display a selected window on top of the others by operating the stylus pen.

The computer 1 has the CPU 11, an internal storage unit 12, and an external storage unit 13 together with the above-stated display unit 2 and the power switch 3, and these are connected via a bus 19, as illustrated in FIG. 2.

The CPU 11 is a processor controlling the operation of the computer 1, and executes programs stored in the internal storage unit 12. As the programs executed by the CPU 11, there is a launcher activation control program 16 to control activation of a launcher in addition to the OS 15. Besides, there are application programs such as a documentation program, a program for creating and sending/receiving electronic mail in the programs executed by the CPU 11.

The internal storage unit 12 is a storage unit mainly storing programs executed by the computer 1, and it can be, for example, a RAM, a flash memory, and an HDD (Hard Disk Drive). In the computer 1, the OS 15 and the launcher activation control program 16 are stored in the internal storage unit 12 as illustrated in FIG. 2. Besides, the internal storage unit 12 includes a later-described display pattern determination table 17 and a specified count storage area 18.

The external storage unit 13 is a storage unit storing programs to be executed, and it can be, for example, a flash memory, a hard disk device, a CD reader, a DVD reader, and so on. The external storage unit 13 stores programs less frequently accessed by the CPU 11, and programs which are not currently executed, differently from the internal storage unit 12.

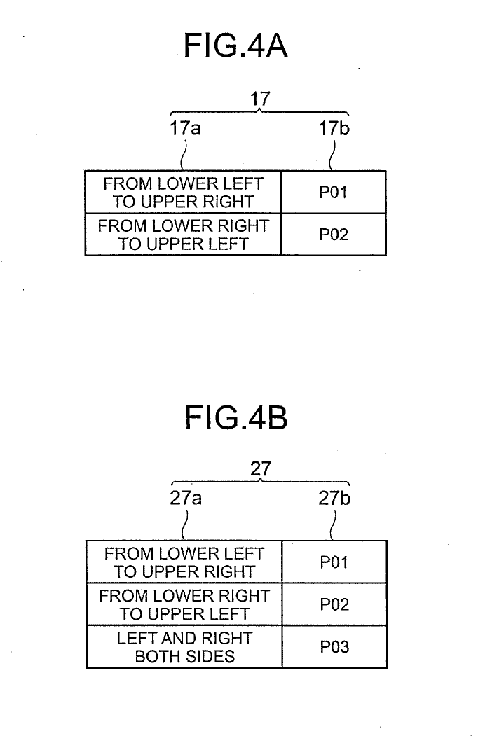

The display pattern determination table 17 has a gesture pattern storage area 17a and a display pattern storage area 17b as illustrated in FIG. 4A, and stores later-described gesture patterns and display patterns in association with each other.

The gesture patterns are stored in the gesture pattern storage area 17a, and the display patterns are stored in the display pattern storage area 17b.

The term “gesture pattern” as used herein means a pattern of finger movement capable of activating the launcher among operations that the user performs by moving his finger on the touch panel 2b while holding the main body 10 in one hand (herein referred to as “finger gesture”, and the details will be described later).

The finger movement pattern can be specified by a move start position where the finger touches the touch panel 2b and starts moving and a moving direction in which the finger moves from the move start position. The pattern of finger movement may be specified by using a moving distance and the number of movements. In the present embodiment, the finger movement pattern is specified by the moving direction, and two gesture patterns “from lower left to upper right”, and “from lower right to upper left” are registered in the gesture pattern storage area 17a.

The term “display pattern” as used herein means a pattern for displaying the launcher GUI (Graphical User Interface) after the launcher is activated. Two display patterns P01 and P02 are registered in the display pattern storage area 17b associated with the respective gesture patterns.

A specified count is stored in the specified count storage area 18. The term “specified count” as used herein means the number of times a later-described first finger gesture needs to be repeated to activate the launcher. In this embodiment, based on input provided through the touch panel 2b, a number registered by the CPU 11 when it operates as a count setting unit has been set as the specified count (while this embodiment assumes that the specified count is “2”, it may be any other number).

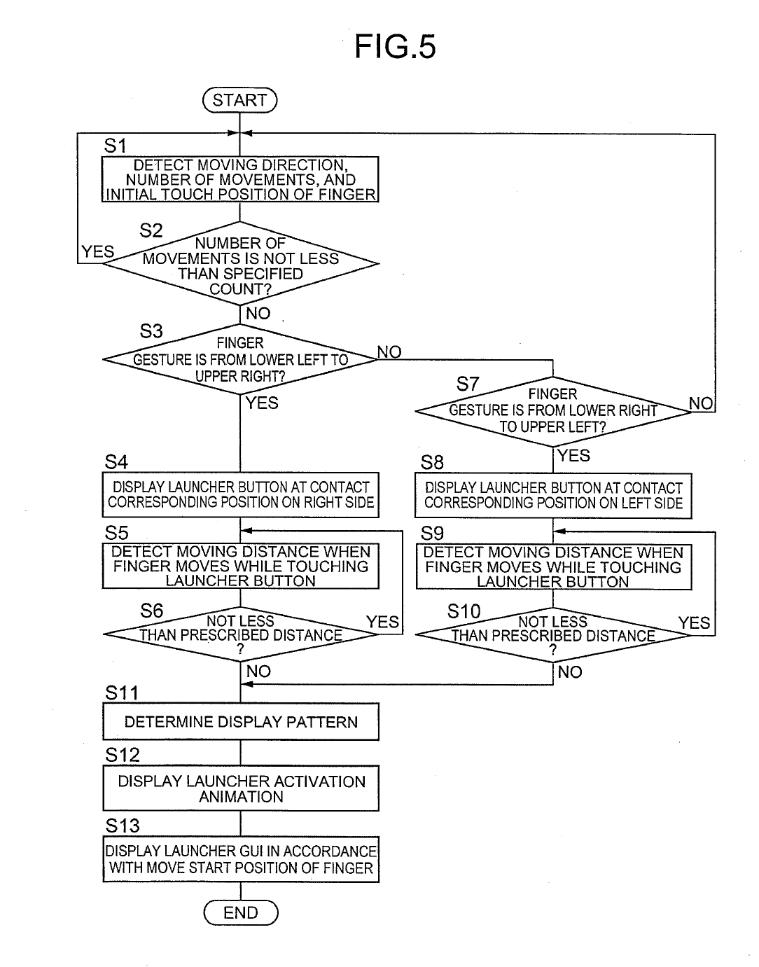

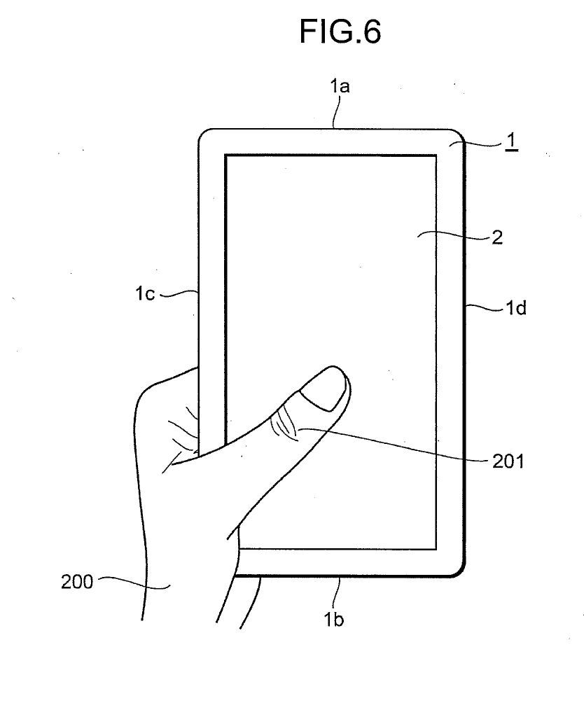

Next, operation of the computer 1 is described with reference to FIG. 5 to FIG. 10. FIG. 5 is a flowchart of an operation procedure of a launcher activation control process in the computer 1. The launcher activation control process is realized by the CPU 11 operating in accordance with the launcher activation control program 16. FIG. 6 to FIG. 10 are views of external appearances of the computer 1 until the launcher is activated by the finger gesture performed by the user.

The CPU 11 starts the operation in accordance with the launcher activation control program 16, and advances the operation to S1 to perform an operation as a detecting unit. Here, the CPU 11 detects an initial contact position, the moving direction, and the number of movements of the finger on the touch panel 2b (here, a thumb is imaged, but of course, the other fingers can be used in the present embodiment) based on input provided through the touch panel 2b. Namely, the CPU 11 detects a position where the finger has touched on the touch panel 2b, and in which direction and how many times the finger has moved from the position.

Next, the CPU 11 advances the operation to S2, and judges whether the number of movements detected at S1 is not less than the specified count or not. Here, the CPU 11 advances the operation to S3 when the number of movements is not less than the specified count, but otherwise, returns to S1.

When the CPU 11 advances the operation to S3, it judges whether the finger gesture is “from lower left to upper right” or not, and advances the operation to S4 when the result is YES, but otherwise, advances the operation to S7.

The CPU 11 advances the operation to S4, then performs an operation as a button display control unit, and displays a later-described launcher button 100 at a contact corresponding position corresponding to the contact position of the finger on the right portion 1d side of the liquid crystal panel 2a.

Subsequently, the CPU 11 advances the operation to S5, performs the operation as the detecting unit, and detects a moving distance of the finger moved on the touch panel 2b as for a second finger gesture (it will be concretely described later) that the user has performed while touching the launcher button 100. Besides, the CPU 11 advances the operation to S6, judges whether the moving distance detected at S5 is not less than a certain distance (prescribed distance) or not, and advances the operation to S11 when the moving distance is not less than the prescribed distance, but otherwise returns to S5.

On the other hand, when advancing the operation from S3 to S7, the CPU 11 judges whether the finger gesture is “from lower right to upper left” or not, and advances the operation to S8 when the result is YES, but otherwise, returns to S1.

The CPU 11 advances the operation to S8, performs the operation as the button display control unit, and displays the launcher button 100 at a contact corresponding position corresponding to the contact position of the finger on the left portion 1c side of the liquid crystal panel 2a.

Subsequently, the CPU 11 advances the operation to S9, performs the operation as the detecting unit, and detects a moving distance of the finger as for the second finger gesture. Besides, the CPU 11 advances the operation to S10, judges whether the moving distance detected at S9 is not less than the prescribed distance or not. Then the CPU 11 advances the operation to S11 when the moving distance is not less than the prescribed distance, but otherwise, returns to S9.

The CPU 11 advances the operation to S11, then refers to the display pattern determination table 17, performs an operation as a GUI determination unit, and determines the display pattern corresponding to the gesture pattern specified by the detection result of S1. The display pattern is determined, and thereby, a form of the launcher GUI to be displayed and positions of icons are determined. Besides, in this case, after determining the display pattern in accordance with the gesture pattern, the CPU 11 changes the launcher GUI, and therefore, the CPU 11 performs an operation as a GUI change unit.

Further, the CPU 11 advances the operation to S12, and displays a launcher activation animation, which is a moving image when the launcher is activated, on the display unit 2. After that, the CPU 11 advances the operation to S13, performs an operation as a display control unit, and displays the launcher GUI (for example, a launcher GUI 120) on the display unit 2 in accordance with the display pattern determined at S11.

At this time, the CPU 11 displays the launcher GUI 120 in accordance with the move start position of the finger among the contact positions of the finger. The move start position of the finger in this case is a position corresponding to the launcher button 100 on the touch panel 2b (because the second finger gesture is performed from the launcher button 100 as stated below), and therefore, the launcher GUI 120 is displayed at a position where the launcher button 100 has been displayed. After that, the CPU 11 finishes the launcher activation control process.

The computer 1 performs the launcher activation control process as stated above, and therefore, display on the display unit 2 changes as illustrated in FIG. 6 to FIG. 10 when the user performs the first finger gesture and the second finger gesture.

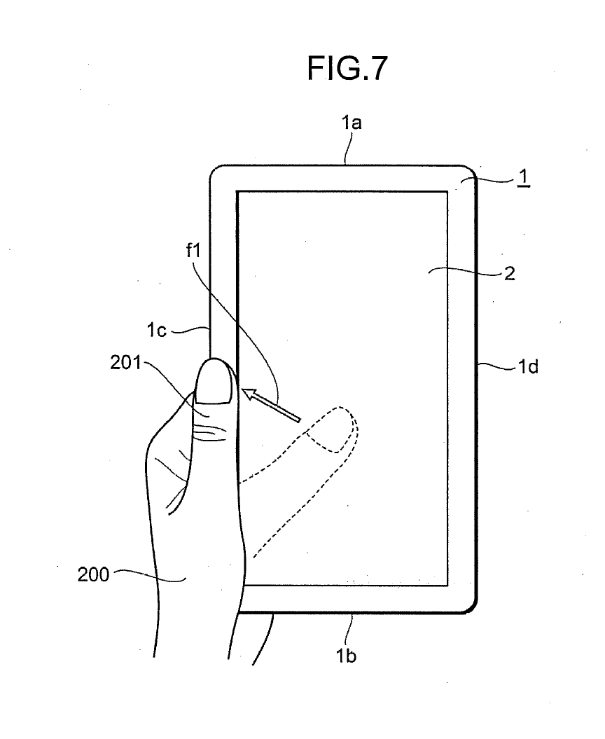

At first, as illustrated in FIG. 6, the user touches the touch panel 2b with his thumb 201 while carrying (holding) the computer 1 in his left hand 200. After that, the user performs a finger gesture shifting the thumb 201 in a direction indicated by an arrow f1 as illustrated in FIG. 7 (this finger gesture to display the launcher button is herein referred to as “first finger gesture”). In this case, the thumb 201 is of the left hand 200, and therefore, a trace of the thumb 201 on the touch panel 2b is formed in a direction from the lower right to the upper left if the finger gesture as indicated by the arrow f1 is performed.

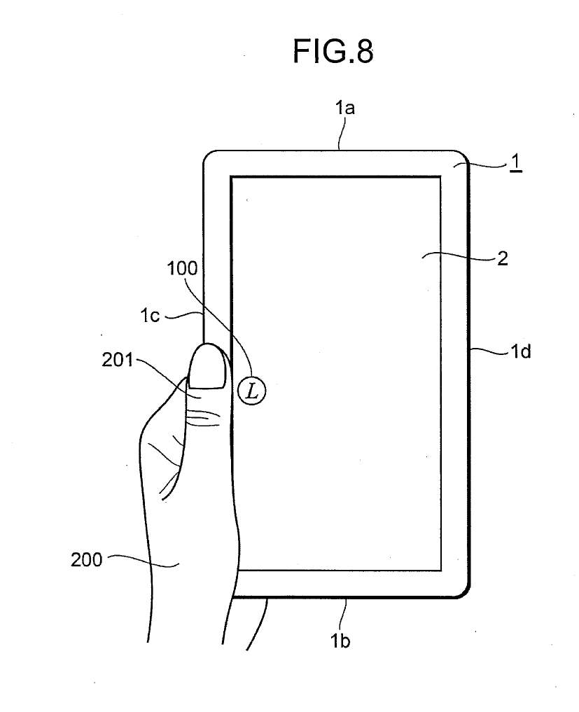

Accordingly, the operation is advanced from S2 to S3 in FIG. 5 if the user continuously performs this first finger gesture twice, and further, the operation is advanced to S3, S7, and S8 sequentially. Accordingly, the computer 1 displays the launcher button 100 on the left portion 1c side as illustrated in FIG. 8.

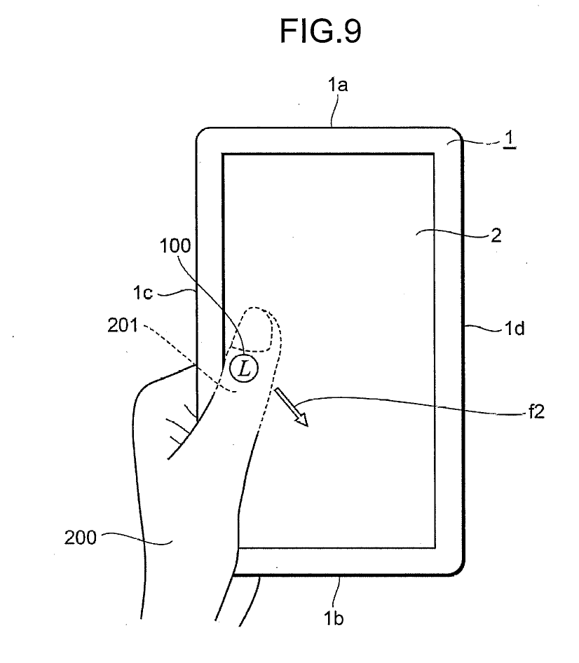

Further, the user touches with the thumb 201 a portion corresponding to the launcher button 100 on the touch panel 2b (hereinafter referred to as “display corresponding portion”), and performs a finger gesture shifting the thumb 201 in a direction of an arrow f2 so as to draw an arc as illustrated in FIG. 9. This finger gesture performed after the first finger gesture to activate the launcher is herein referred to as “second finger gesture”.

When the moving distance of the thumb 201 resulting from the second finger gesture is not less than the prescribed distance, the operation is advanced to S9, S10, and S11 sequentially, and the display pattern is determined. In the above-stated case, the gesture pattern by the first finger gesture is “from lower right to upper left”, and therefore, the display pattern is determined to be “P02” from the display pattern determination table 17.

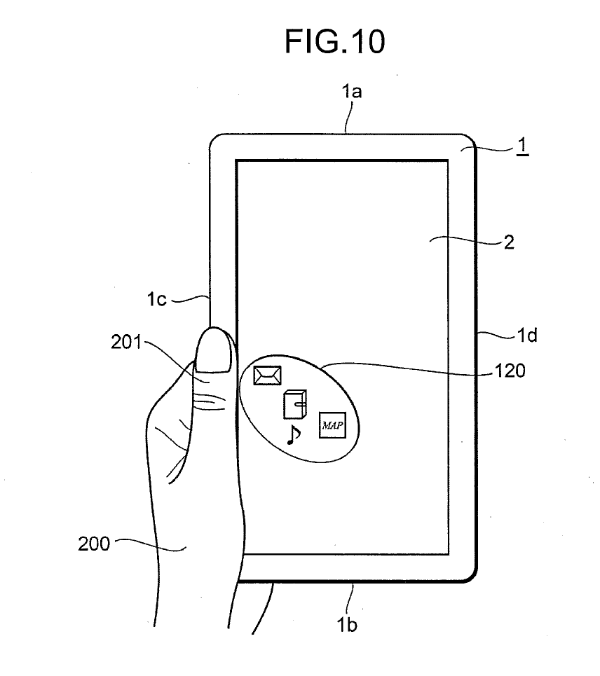

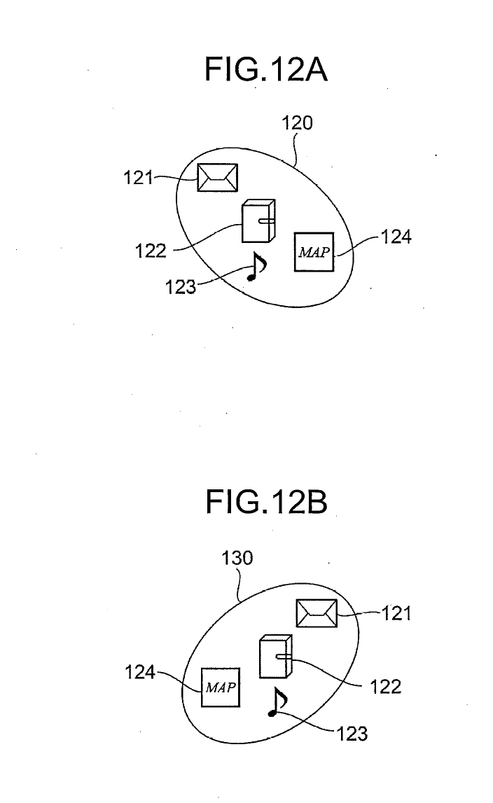

The launcher GUI corresponding to the display pattern P02 is displayed as the launcher GUI 120 illustrated in FIG. 10 and FIG. 12A, and it is displayed at a position where the launcher button 100 has been displayed on the left portion 1c side.

The launcher GUI 120 represents that the launcher is in an activation state, and includes icons 121, 122, 123, and 124 of registered applications. Besides, the launcher GUI 120 is displayed such that the icons 121, 122, 123, and 124 are disposed at positions corresponding to a left hand operation within a reaching range of the thumb 201 to allow the user to operate them with the thumb 201 easily.

The computer 1 activates the launcher to display the launcher GUI 120, and displays that the launcher is activated by means of the launcher GUI 120. It means that the launcher is activated when the launcher GUI 120 is displayed. Accordingly, in response to user's operation to select a desired icon (for example, the icon 121), the corresponding application is activated.

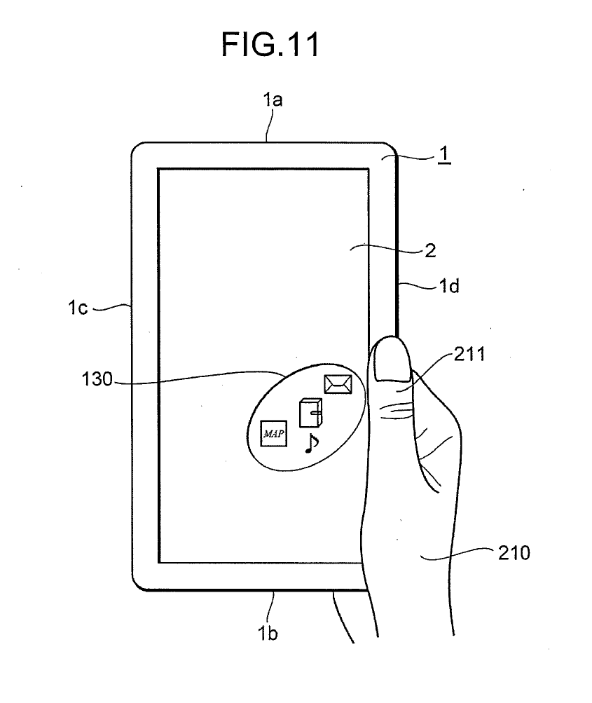

On the other hand, assume that the user performs the first finger gesture by using his thumb 211 while carrying (holding) the computer 1 in his right hand 210 as illustrated in FIG. 11. In this case, the thumb 211 is of the right hand 210, and therefore, a trace of the thumb 211 on the touch panel 2b is formed in a direction from the lower left to the upper right if the first finger gesture is performed.

Accordingly, when the user continuously performs this first finger gesture twice, the operation is advanced to S2, S3, S4, and S5 sequentially in FIG. 5, and the launcher button is displayed on the right portion 1d side (this point is not illustrated).

When the user further performs the second finger gesture while touching with the thumb 211 a display corresponding portion corresponding to the launcher button on the touch panel 2b, the operation is advanced to S5, S6, S11 sequentially when the moving distance of the thumb 211 is not less than the prescribed distance, and the display pattern is determined. The first finger gesture in this case is “from lower left to upper right”, and therefore, the display pattern is determined to be “P01” by the display pattern determination table 17.

The launcher GUI corresponding to the display pattern P01 is displayed as a launcher GUI 130 in FIG. 11 and FIG. 12B, and it is displayed at a position where the launcher button 100 has been displayed on the right portion 1d side.

The launcher GUI 130 represents that the launcher is in the activation state, and includes the icons 121, 122, 123, and 124 of registered applications as with the launcher GUI 120. Besides, in the launcher GUI 130, the icons 121, 122, 123, and 124 are disposed at positions corresponding to a right hand operation within a reaching range of the thumb 211 such that the user can operate them with the thumb 211 easily. In addition, the form and the positions of respective icons are different from those of the launcher GUI 120 so as to fit for the right hand operation.

As stated above, in the computer 1, the launcher button 100 is displayed under a predetermined condition when the-user performs the first finger gesture on the touch panel 2b. Further, the launcher is activated under a predetermined condition and the launcher GUI 120 or 130 corresponding to the side on which the finger gesture has been performed is displayed when the second finger gesture is performed.

Accordingly, in the computer 1, it is possible to activate the launcher with one hand having the computer 1 without operating the operation input device regardless whether the computer 1 is carried by either the left hand or the right hand, because the launcher can be activated only by the finger gesture of the thumb. Accordingly, it becomes possible to reduce the stress of the user at a screen operation time, and to realize the GUI (Graphical User Interface) which is more visceral and based on human engineering.

Consequently, for example, when the user talks over a cellular phone while holding it in one hand, it is possible to activate the launcher with the other hand holding the computer 1, and, for example, to check his schedule and so on by activating a schedule program registered in the launcher.

It is possible to activate the launcher with one holding hand even if the main body 10 is carried laterally or obliquely in addition to the case when the main body 10 is carried longitudinally. Besides, the dispositions of the icons are optimized, and therefore, it is easy to use.

In addition, the launcher GUI 120 is displayed in accordance with the contact position of the finger at the left portion 1c side when the first and second finger gestures are performed by the thumb 201 of the left hand 200, and the launcher GUI 130 is displayed in accordance with the contact position of the finger at the right portion 1d side when the first and second finger gestures are performed by the thumb 211 of the right hand 210.

The launcher GUI 120 or 130 is displayed within a movable range of the thumbs 201 or 211, and therefore, an application activation operation and a data input operation and so on after the activation of the launcher can be performed easily by the same holding hand without changing the hand holding the main body 10. In addition, it is possible to display the launcher GUI 120 or 130 at a position where the display of application is not disturbed.

Further, the forms of the launcher GUI 120 and the launcher GUI 130 are different in accordance with the hands performing the finger gestures, and therefore, the operation after the activation of the launcher becomes easier to perform. The positions of respective icons are also different, and therefore, the operation of the holding hand is easy to perform.

Besides, the launcher button is displayed only when the first finger gesture is repeated a number of times not less than the specified count. Further, the launcher is activated when the second finger gesture is performed by moving the finger by not less than the determined distance from the launcher button. Accordingly, in the computer 1, it is possible to limit an activation condition of the launcher so as not to activate the launcher by an erroneous operation and so on. The specified count can be registered by the user, and therefore, it is possible for the user to define the activation condition of the launcher. Accordingly, flexibility in changing the activation condition is increased.

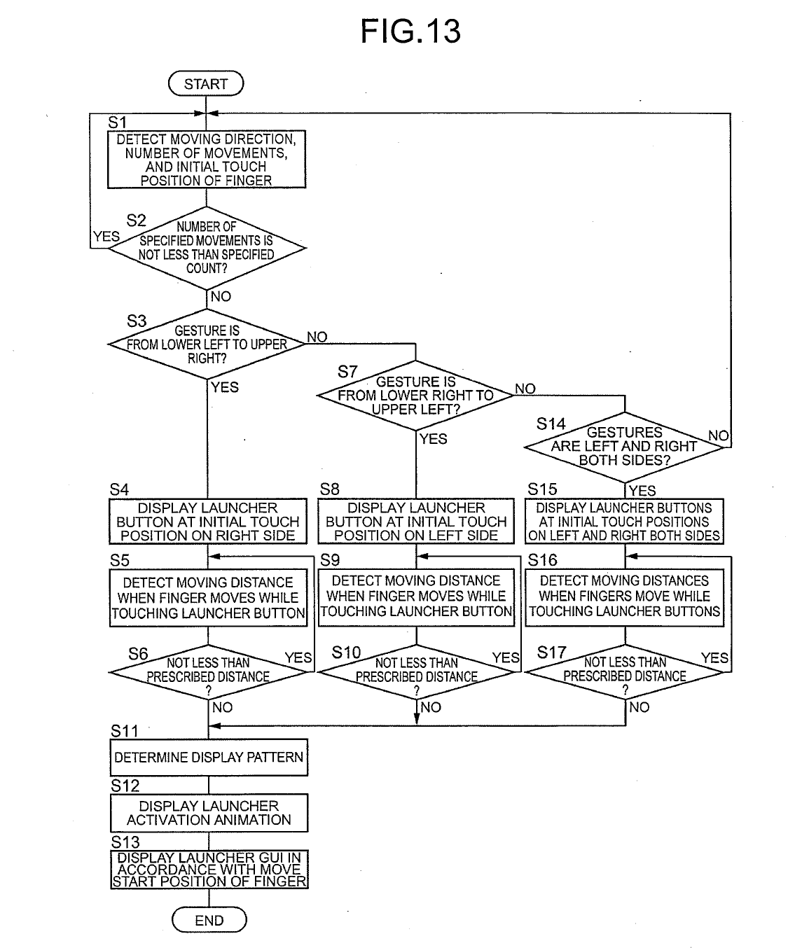

On the other hand, the computer 1 can perform the launcher activation control process according to a flowchart of FIG. 13. In FIG. 13, the process from S14 to S17 is different from the flowchart of FIG. 5, and S7 is different resulting from the process of S14 to S17.

The CPU 11 advances the operation from S3 to S7, judges whether the finger gesture is “from lower right to upper left” or not, and advances the operation to S8 when the result is YES, but otherwise, advances the operation to S14.

Besides, the CPU 11 advances the operation to S14, then judges whether the finger gesture is “left and right both sides” or not, advances the operation to S15 when the result is YES, but otherwise, returns to S1.

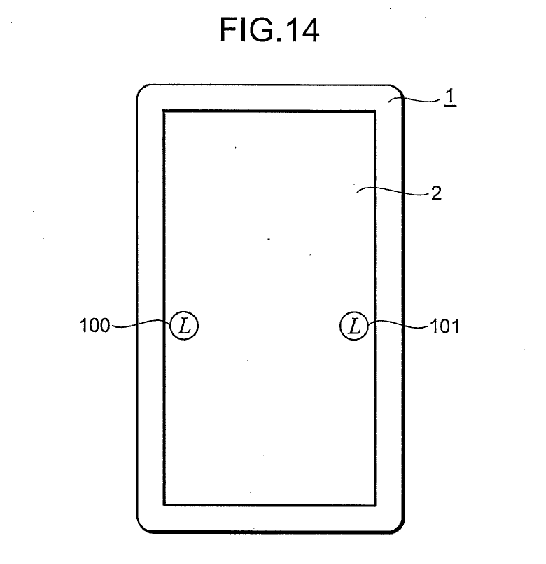

The CPU 11 advances the operation to S15, then performs the operation as the button display control unit, and respectively displays the launcher button 100 at the contact position of the finger on the left portion 1c side and a launcher button 101 at the contact position of the finger on the right portion 1d side as illustrated in FIG. 14.

Subsequently, the CPU 11 advances the operation to S16, performs the operation as the detecting unit, and detects the moving distance of the finger as for the second finger gesture. Besides, the CPU 11 advances the operation to S17, and judges whether the moving distance detected at S16 is not less than the prescribed distance or not. The CPU 11 advances the operation to S11 when the moving distance is not less than the prescribed distance, but otherwise, returns to S16.

The CPU 11 advances the operation to S11, then performs the operation as the GUI determination unit with reference to the display pattern determination table 17, and determines the display pattern corresponding to the gesture pattern. After that, the CPU 11 operates in the same manner as previously described in connection with FIG. 5, and finishes the launcher activation control process.

In this case, the user performs the first finger gesture by using both the thumbs 201 and 211, and therefore, the launcher buttons 100 and 101 are displayed as illustrated in FIG. 14. When the user performs the second gesture while touching with the thumbs 201 and 211 the display corresponding portions of the launcher buttons 100 and 101, respectively, the display pattern is determined to be “P03” by referring to a display pattern determination table 27 as illustrated in FIG. 4B at S11. The display pattern determination table 27 is different from the display pattern determination table 17 in that the display pattern P03 corresponding to the gesture pattern for the “left and right both sides” is added.

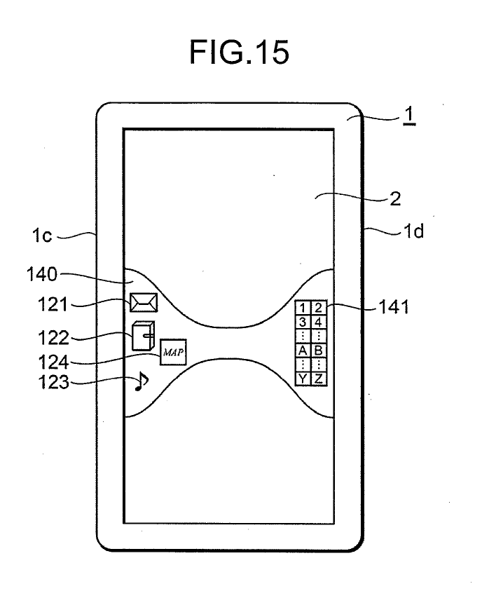

A launcher GUI corresponding to the display pattern P03 is displayed as a launcher GUI 140 illustrated in FIG. 15. This launcher GUI 140 includes the icons 121, 122, 123, and 124 on the left portion 1c side, and in addition, a character input portion 141 for inputting characters, numerals, symbols and so on is provided on the right portion 1d side.

Accordingly, when the launcher GUI 140 is displayed, it is possible to perform operations such as icon selection with the left hand 200, and input of characters and so on with the right hand 210 concurrently, and convenience is enhanced.

Incidentally, a description is given above of two types of gesture patterns, “from lower left to upper right”, and “from lower right to upper left”, or three types of them, “left and right both sides” is added; however, other patterns, for example, “from bottom to top”, “from top to bottom”, and “draw circle” may be registered.

The launcher GUI may include the icons of applications other than the above-stated four kinds of applications, and may include data of date, time and so on.

Besides, the computer 1 is described above as having a size portable with one hand, but the present embodiment can be applied to a note-type computer portable with both hands.

The above description is for explaining an embodiment of the invention and does not limit the apparatus and the method of the invention, and various modifications can be easily made to the invention. Further, an apparatus or a method formed by appropriately combining the components, functions, features or method steps in each embodiment is also included in the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus that includes a display device and a contact input device arranged on the display device and receiving data corresponding to a contact position of a finger, the information processing apparatus comprising:
a detecting unit that detects a movement pattern of the finger touching the contact input device;
a GUI determination unit that determines a launcher GUI (Graphical User Interface) including one or more icons in accordance with the movement pattern detected by the detecting unit; and
a display control unit that displays the launcher GUI determined by the GUI determination unit on the display device in accordance with a contact position of the finger on the contact input device.

2. The information processing apparatus according to claim 1, further comprising a GUI change unit that changes a form of the launcher GUI and positions of the icons in accordance with the movement pattern detected by the detecting unit.

3. The information processing apparatus according to claim 1, wherein
the detecting unit detects a moving direction of the finger and a move start position of the finger on the contact input device as the movement pattern, and
the display control unit displays the launcher GUI at a position in accordance with the move start position detected by the detecting unit among contact positions of the finger.

4. The information processing apparatus according to claim 3, wherein
the detecting unit detects the number of movements of the finger on the contact input device as the movement pattern, and
the display control unit displays the launcher GUI only when the number of movements detected by the detecting unit is not less than a specified count.

5. The information processing apparatus according to claim 3, wherein
the detecting unit detects a moving distance of the finger on the contact input device as the movement pattern, and
the display control unit displays the launcher GUI only when the moving distance detected by the detecting unit is not less than a determined prescribed distance.

6. The information processing apparatus according to claim 3, further comprising a button display control unit that displays a launcher button to activate a launcher on the display device when the number of movements is not less than a specified count, wherein
the display control unit displays the launcher GUI only when the finger moves on the contact input device not less than a determined prescribed distance from a position corresponding to the launcher button.

7. The information processing apparatus according to claim 4, further comprising a count setting unit that sets the specified count based on data from the contact input device.

8. The information processing apparatus according to claim 3, further comprising a rectangular apparatus main body having the display device built therein, wherein
the display control unit displays the launcher GUI in accordance with a move start position of a thumb of a hand holding the apparatus main body as the move start position.

9. A computer program product embodied on a computer-readable medium and comprising codes that, when executed on a computer including a display device and a contact input device arranged on the display device and receiving data corresponding to a contact position of a finger, causes the computer to perform:
detecting a movement pattern of the finger touching the contact input device;
determining a launcher GUI (Graphical User Interface) including one or more icons in accordance with the movement pattern detected at the detecting; and
displaying the launcher GUI determined at the determining on the display device in accordance with a contact position of the finger on the contact input device.

10. A launcher activation control method applied to an information processing apparatus including a display device and a contact input device arranged on the display device and receiving data corresponding to a contact position of a finger, the launcher activation control method comprising:
detecting a movement pattern of the finger touching the contact input device;
determining a launcher GUI (Graphical User Interface) including one or more icons in accordance with the movement pattern detected at the detecting; and
displaying the launcher GUI determined at the determining on the display device in accordance with a contact position of the finger on the contact input device.
